(19) United States
(12) Patent Application Publication
(10) Pub. No.: US 2007/0081479 A1
(43) Pub. Date: Apr. 12, 2007

(54) Apparatus and method for negotiating relay station capacity in a multi-hop relay broadband wireless access communication system

(75) Inventors: Hyun-Jeong Kang, Seoul (KR); Pan-Yuh Joo, Seoul (KR); Jung-Je Son, Seongnam-si (KR); Jae-Weon Cho, Suwon-si (KR); Hyoung-Kyu Lim, Seoul (KR); Yeong-Moon Son, Seoul (KR); Sung-Jin Lee, Seoul (KR); Mi-Hyun Lee, Seoul (KR); Song-Nam Hong, Seoul (KR); Young-Ho Kim, Suwon-si (KR)

Correspondence Address: DILWORTH & BARRESE, LLP, 333 EARLE OVINGTON BLVD., SUITE 702, UNIONDALE, NY, 11553, US

(73) Assignee: Samsung Electronics Co., Ltd., Suwon-si (KR)

(21) Appl. No.: 11/543,375

(22) Filed: Oct. 5, 2006

(30) Foreign Application Priority Data
Oct. 6, 2005 (KR) 2005-0093831

(51) Int. Cl. H04B 7/00

(52) U.S. Cl. 370/310

(57) ABSTRACT

An apparatus and method for negotiating an RS capability in a multi-hop relay BWA communication system are provided. A BS receives a message including RS capability information from a node which has initially been connected. The BS determines whether to activate a relay function for the node according to the RS capability information and sends to the node a message indicating whether the relay function will be activated for the node.

### PRIORITY

This application claims priority under 35 U.S.C. § 119 to an application entitled “Apparatus and Method for Negotiating Relay Station Capability in a Multi-Hop Relay Broadband Wireless Access Communication System” filed in the Korean Intellectual Property Office on Oct. 6, 2005 and assigned Ser. No. 2005-93831, the contents of which are incorporated herein by reference.

### BACKGROUND OF THE INVENTION

1. Field of the Invention

The present invention relates generally to a multi-hop relay Broadband Wireless Access (BWA) communication system, and in particular, to an apparatus and method for deactivating a relay function from a node serving as a Relay Station (RS) and activating the relay function for a node supporting the relay function.

2. Description of the Related Art

Provisioning of services with diverse Quality of Service (QoS) levels at about 100 Mbps to users is an active study area for a future-generation communication system called a 4^{th} Generation (4G) communication system. Particularly, active research is conducted on provisioning of high-speed service by ensuring mobility and QoS to a BWA communication system such as a Wireless Local Area Network (WLAN) and a Wireless Metropolitan Area Network (WMAN). Major examples are Institute of Electrical and Electronics Engineers (IEEE) 802.16a and IEEE 802.16e systems.

The IEEE 802.16a and IEEE 802.16e communication systems adopt Orthogonal Frequency Division Multiplexing/Orthogonal Frequency Division Multiple Access (OFDM/OFDMA) to physical channels. IEEE 802.16a considers only a single-cell structure with no regard to mobility of Subscriber Stations (SSs). In contrast, IEEE 802.16e supports the SS's mobility to the IEEE 802.16a communication system. Hereinafter, a mobile SS is called an MS.

FIG. 1 illustrates the configuration of a typical IEEE 802.16e communication system.

Referring to FIG. 1, the IEEE 802.16e communication system is configured in a multi-cell structure. Specifically, it is comprised of cells 100 and 150, BSs 110 and 140 for managing the cells 100 and 150, respectively, and a plurality of MSs 111, 113, 130, 151 and 153. Signals are sent in OFDM/OFDMA between the BSs 110 and 140 and the MSs 111, 113, 130, 151 and 153. The MS 130 is located in a cell boundary area between the cells 100 and 150, i.e. in a handover region. When the MS 130 moves to the cell 150 managed by the BS 140 during signal transmission/reception to/from the BS 110, the serving BS of the MS 130 is changed from the BS 110 to the BS 140.

Since signaling is carried out between an MS and a fixed BS via a direct link as illustrated in FIG. 1, a highly reliable radio communication link can be established between them in the typical IEEE 802.16e communication system. However, due to the fixedness of BSs, a wireless network cannot be configured with flexibility. As a result, the IEEE 802.16e communication system is not effective in efficiently providing communication services under a radio environment experiencing a fluctuating traffic distribution and a great change in the number of required calls.

These problems may be solved by applying a multi-hop relay data transmission scheme using fixed RSs, mobile RSs, or general MSs to general cellular wireless communication systems such as IEEE 802.16e. The multi-hop relay wireless communication system can advantageously reconfigure a network rapidly according to a communication environmental change and enables efficient operation of the whole wireless network, and can expand cell coverage and increase system capacity. In the case where the channel status between a BS and an MS is poor, an RS installed between them results in the establishment of a multi-hop relay path through the RS which renders a better radio channel available to the MS. With the use of the multi-hop relay scheme at a cell boundary where the channel status is poor, high-speed data channels become available and the cell coverage is expanded.

FIG. 2 illustrates the configuration of a multi-hop relay BWA communication system.

Referring to FIG. 2, the multi-hop relay BWA communication system, which is configured in a multi-cell structure, includes cells 200 and 240, BSs 210 and 250 for managing the cells 200 and 240, respectively, a plurality of MSs 211 and 213 within the coverage area of the cell 200, a plurality of MSs 221 and 223 managed by the BS 210 but located in an area 230 outside the cell 200, an RS 220 for providing a multi-hop relay path between the BS 210 and the MSs 221 and 223 within the area 230, a plurality of MSs 251, 253 and 255 within the coverage area of the cell 240, a plurality of MSs 261 and 263 managed by the BS 250 but located in an area 270 outside the cell 240, and an RS 260 for providing a multi-hop relay path between the BS 250 and the MSs 261 and 263 within the area 270. Signals are sent in OFDM/OFDMA among the BSs 210 and 250, the RSs 220 and 260, and the MSs 211, 213, 221, 223, 251, 253, 255, 261 and 263.

Although the MSs 211 and 213 within the coverage area of the cell 200 and the RS 220 can communicate directly with the BS 210, the MSs 221 and 223 within the area 230 cannot communicate with the BS 210, directly. Therefore, the RS 220 covering the area 230 relays signals between the BS 210 and the MSs 211 and 223. That is, the MSs 221 and 223 exchange signals with the BS 210 through the RS 220. Meanwhile, although the MSs 251, 253 and 255 within the coverage area of the cell 240 and the RS 260 can communicate directly with the BS 250, the MSs 261 and 263 within the area 270 cannot communicate with the BS 250, directly. Therefore, the RS 260 covering the area 270 relays signals between the BS 250 and the MSs 261 and 263. That is, the MSs 261 and 263 exchange signals with the BS 250 through the RS 260.

FIG. 3 illustrates the configuration of a multi-hop relay BWA communication system configured to increase system capacity.

Referring to FIG. 3, the multi-hop relay wireless communication system includes a BS 310, a plurality of MSs 311, 313, 321, 323, 331 and 333, and RSs 320 and 330 for providing multi-hop relay paths between the BS 310 and the MSs. Signaling is carried out in OFDM/OFDMA among the BS 310, the RSs 320 and 330 and the MSs 311, 313, 321, 323, 331 and 333. The BS 310 manages a cell 300, and the MSs 311, 313, 321, 323, 331 and 333 within the coverage area of the cell 300 and the RSs 320 and 330 can communicate directly with the BS 310.

Yet, the direct links between the BS 310 and the MSs 321, 323, 331 and 333 close to the boundary of the cell 300 may have low Signal-to-Noise Ratios (SNRs). Therefore, the RS 320 relays unicast traffic between the BS 310 and the MSs 321 and 323 so that the MSs 321 and 323 send and receive unicast traffic to and from the BS 310 via the RS 320. The RS 330 relays unicast traffic between the BS 310 and the MSs 331 and 333 so that the MSs 331 and 333 send and receive unicast traffic to and from the BS 310 via the RS 330. That is, the RSs 320 and 330 provide high-speed data transmission paths to the MSs 321, 323, 331 and 333, thereby increasing the effective data rates of the MSs and the system capacity.

In the multi-hop relay BWA communication systems illustrated in FIGS. 2 and 3, the RSs 220, 260, 320 and 330 are infrastructure RSs installed and managed by the BSs 210, 250 and 310, or client RSs which SSs or MSs serve. The RSs 220, 260, 320 and 330 may also be fixed, nomadic (e.g. laptop), or mobile (e.g. MSs or systems installed in the vehicles).

In the above-described multi-hop relay BWA communication system, a BS selects an RS for relaying between an MS and the BS during a basic capabilities negotiation in an initial connection procedure. When a node supporting a relay function (an RS-capable node) sends RS capability information to the BS, indicating its support of the relay function, the BS decides whether to select the node as an RS. This decision is made for the purpose of increasing system capacity or expanding the coverage of the BS. According to the decision, some of RS-capable nodes operate as RSs, while others do not.

Meanwhile, there exists a need for defining a method of activating the relay function for an RS-capable node which was not selected as an RS by the BS during the initial connection procedure for the purpose of increasing system capacity or expanding the coverage of the BS, and a method of, in the middle of communications, deactivating the relay function from a node selected as an RS in the initial connection procedure. That is, a method and procedure need to be specified in the multi-hop relay BWA communication system, for activating and deactivating the relay function for RS-capable nodes after the initial connection procedure.

### SUMMARY OF THE INVENTION

An object of the present invention is to substantially solve at least the above problems and/or disadvantages and to provide at least the advantages below. Accordingly, an object of the present invention is to provide an apparatus and method for negotiating an RS capability in a multi-hop relay BWA communication system.

Another object of the present invention is to provide an apparatus and method for deactivating a relay function from a node serving as an RS after an initial connection procedure in a multi-hop relay BWA communication system.

A further object of the present invention is to provide an apparatus and method for activating a relay function for an RS-capable node which has not been selected as an RS, after an initial connection procedure in a multi-hop relay BWA communication system.

The above objects are achieved by providing an apparatus and method for negotiating an RS capability in a multi-hop relay BWA communication system.

According to one aspect of the present invention, in a method of negotiating an RS capability in a BS in a multi-hop relay BWA communication system, the BS receives a message including RS capability information from a node which has initially been connected. The BS determines whether to activate a relay function for the node according to the RS capability information and sends to the node a message indicating whether the relay function will be activated for the node.

According to another aspect of the present invention, in a method of negotiating relay function activation in a BS in a multi-hop relay BWA communication system, the BS determines whether to activate a relay function for an RS-capable node, selects a node from a potential RS list when it is determined that the relay function needs to be activated for the RS-capable node, and sends a relay function activation request message to the selected node. The BS receives from the node a relay function activation response message indicating whether the relay function activation request is confirmed or rejected.

According to a third aspect of the present invention, in a method of negotiating relay function activation in a node in a multi-hop relay BWA communication system, the node receives a relay function activation request message from a BS during a communication procedure as a normal node. The node determines whether to confirm or reject the relay function activation request and sends to the BS a relay function activation response message indicating whether the relay function activation request is confirmed or rejected.

According to a fourth aspect of the present invention, in a method of negotiating relay function deactivation in a BS in a multi-hop relay BWA communication system, the BS determines whether to deactivate a relay function from a node functioning as an RS and sends a relay function deactivation notification message to the node, when it is determined to deactivate the relay function from the node. The BS receives from the node a relay function deactivation response message confirming the relay function deactivation notification.

According to a fifth aspect of the present invention, in a method of negotiating relay function deactivation in a node in a multi-hop relay BWA communication system, the node receives a relay function deactivation notification message from a BS during a communication procedure as an RS. The node sends to the BS a relay function deactivation response message confirming the relay function deactivation notification.

According to a sixth aspect of the present invention, in a method of negotiating relay function deactivation in a node in a multi-hop relay BWA communication system, the node determines whether to deactivate a relay function during a communication procedure as an RS, and sends a relay function deactivation request message to a BS, if it determines to deactivate the relay function. The node receives from the BS a relay function deactivation response message indicating whether the relay function deactivation request is confirmed or rejected.

According to a seventh aspect of the present invention, in a method of negotiating relay function deactivation in a BS in a multi-hop relay BWA communication system, upon receipt of a relay function deactivation request message from a node, the BS determines whether to confirm or reject the relay function deactivation request and sends to the node a relay function deactivation response message indicating whether the relay function deactivation request is confirmed or rejected.

According to an eighth aspect of the present invention, in a method of negotiating relay function activation in a multi-hop relay BWA communication system, a BS determines whether to activate a relay function for an RS-capable node, selects a node from a potential RS list when it determines to activate the relay function for the RS-capable node, and sends a relay function activation request message to the selected node. The node determines whether to confirm or reject the relay function activation request and sends to the BS a relay function activation response message indicating whether the relay function activation request is confirmed or rejected.

According to a ninth aspect of the present invention, in a method of negotiating relay function deactivation in a multi-hop relay BWA communication system, a BS determines whether to deactivate a relay function from a node functioning as an RS and sends a relay function deactivation notification message to the node, when determining to deactivate the relay function from the node. The node sends to the BS a relay function deactivation response message confirming the relay function deactivation notification.

According to a tenth aspect of the present invention, in a method of negotiating relay function deactivation in a multi-hop relay BWA communication system, a node determines whether to deactivate a relay function during a communication procedure as an RS. If it determines to deactivate the relay function, it sends a relay function deactivation request message to a BS. The BS determines whether to confirm or reject the relay function deactivation request and sends to the node a relay function deactivation response message indicating whether the relay function deactivation request is confirmed or rejected.

According to an eleventh aspect of the present invention, in an apparatus for negotiating an RS capability in a multi-hop relay BWA communication system, a BS determines whether to activate or deactivate a relay function for a node, sends a first relay function activation or deactivation request message to the node, and receives from the node a first relay function activation or deactivation response message indicating whether the relay function activation or deactivation request is confirmed or rejected. Upon receipt of a second relay function deactivation request message from the node, the BS determines whether to confirm or reject a relay function deactivation request and sends to the node a second relay function deactivation response message indicating whether the relay function deactivation request is confirmed or rejected. Upon receipt of the first relay function activation or deactivation request message from the BS, the node determines whether to confirm or reject the relay function activation or deactivation request and sends the first relay function activation or deactivation response message indicating whether the relay function activation or deactivation request is confirmed or rejected. The node determines whether to deactivate the relay function from the node. If it determines to deactivate the relay function, the node sends the second relay function deactivation request message to the BS.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates the configuration of a typical IEEE 802.16e communication system;

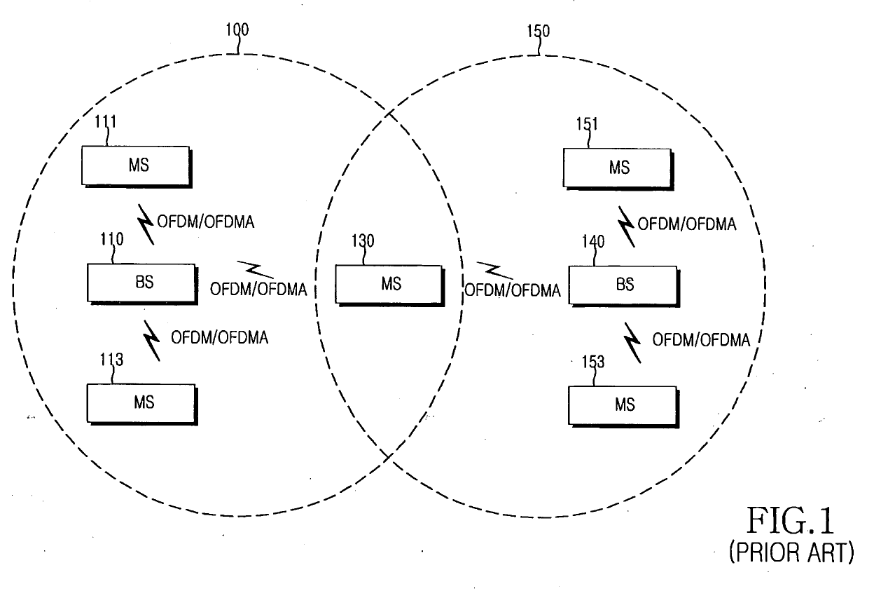

FIG. 2 illustrates the configuration of a multi-hop relay BWA communication system;

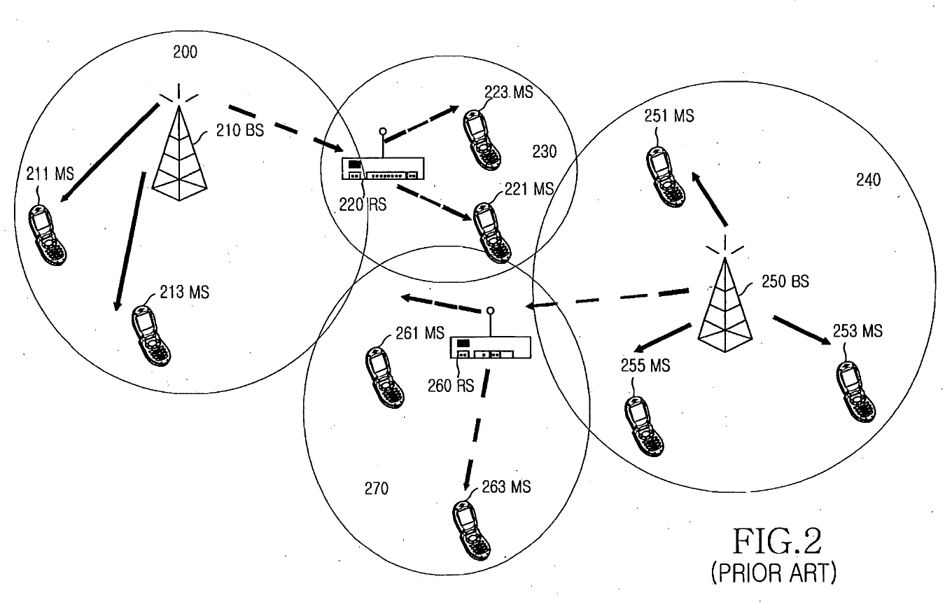

FIG. 3 illustrates the configuration of a multi-hop relay BWA communication system configured to increase system capacity;

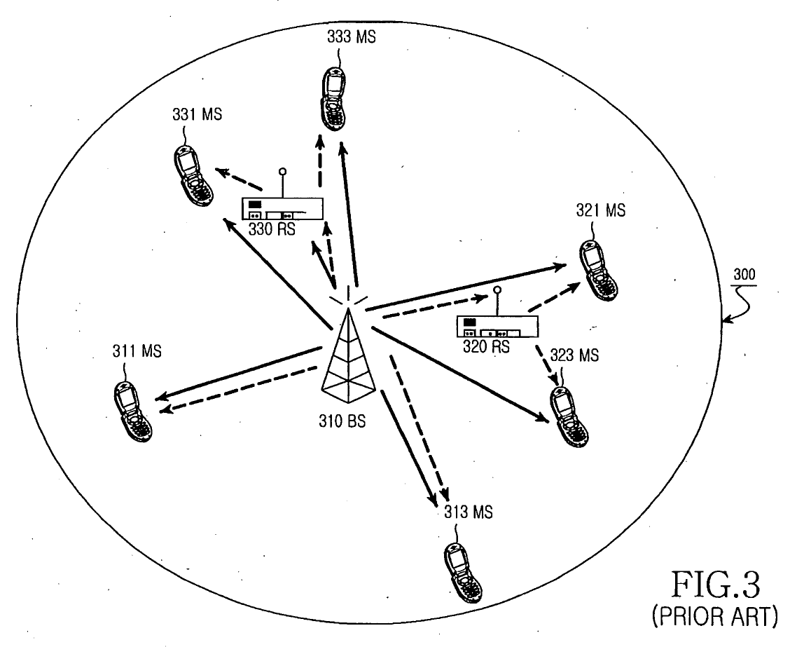

FIG. 4 is a flowchart illustrating an operation for activating/deactivating the relay function for/from an RS-capable node which has been initially connected in a multi-hop relay BWA communication system according to the present invention;

FIG. 5 is a flowchart illustrating an operation for requesting relay function activation to a node included in a potential RS list in a BS in the multi-hop relay BWA communication system according to the present invention;

FIG. 6 is a flowchart illustrating an operation of the node when it receives the relay function activation request from the BS in the multi-hop relay BWA communication system according to the present invention;

FIG. 7 is a flowchart illustrating an operation for requesting relay function deactivation to the node in the BS in the multi-hop relay BWA communication system according to the present invention;

FIG. 8 is a flowchart illustrating an operation of the node when it receives the relay function deactivation request from the BS in the multi-hop relay BWA communication system according to the present invention;

FIG. 9 is a flowchart illustrating an operation for requesting relay function deactivation to the BS in a node serving as an RS in the multi-hop relay BWA communication system according to the present invention;

FIG. 10 is a flowchart illustrating an operation of the BS, when it receives the relay function deactivation request from the node in the multi-hop relay BWA communication system according to the present invention; and

FIG. 11 is a block diagram of the node or the BS according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The present invention provides an apparatus and method for negotiating an RS capability with a node supporting a relay function in a multi-hop relay BWA communication system.

The multi-hop relay BWA communication system operates in OFDM/OFDMA, by way of example. As a physical channel signal is delivered on a plurality of subcarriers, the OFDM/OFDMA operation enables high-speed data transmission. Also, the MS's mobility is supported because the multi-hop relay BWA communication system has a multi-cell structure.

While the present invention is described in the context of the BWA communication system, it is to be understood that the present invention is applicable to any multi-hop relay cellular communication system.

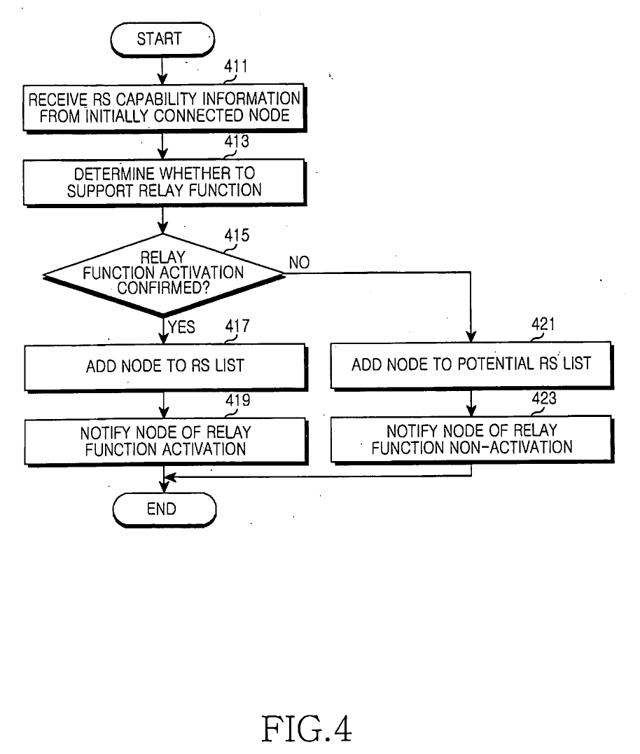

FIG. 4 is a flowchart illustrating an operation for activating/deactivating the relay function for/from an RS-capable node which has been initially connected in a multi-hop relay BWA communication system according to the present invention.

Referring to FIG. 4, a BS receives RS capability information from a node during an initial connection procedure in step 411. The RS capability information indicates whether the node supports the relay function and whether the supported relay function is of a nomadic RS, a mobile RS, an infrastructure RS, or a client RS.

In step 413, the BS determines from the RS capability information whether the node supports the relay function.

If the node supports the relay function, the BS determines whether to confirm the relay function for the node depending on whether the BS seeks to expand its coverage area or increase system capacity in step 415. If it determines to confirm the relay function for the node, the BS adds the node to an RS list in step 417 and notifies the node that the relay function will be activated for the node in step 419. On the contrary, if it determines not to confirm the relay function for the node, the BS adds the node to a potential RS list in step 421 and notifies the node that the relay function will not be activated for the node in step 423. The potential RS list includes information about RS-capable nodes which have not been selected as RSs during initial connection but can be later during communications.

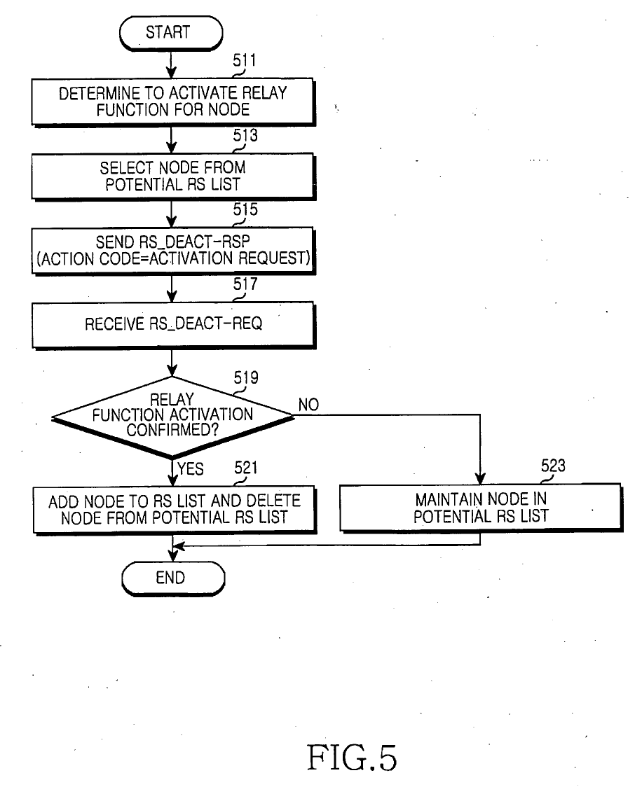

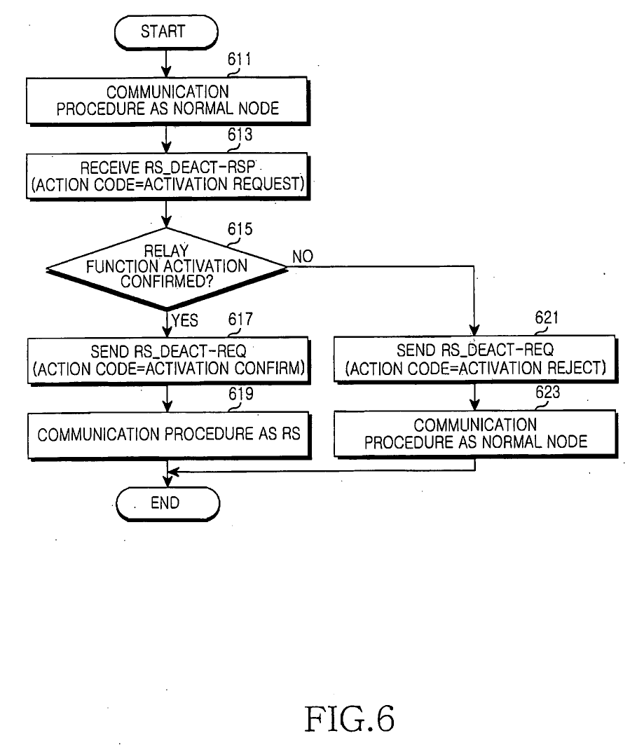

With reference to FIGS. 5 and 6, a description will be made of an operation between the BS and an RS-capable node which does not operate as an RS as listed in a potential RS list, for requesting relay function activation when needed.

FIG. 5 is a flowchart illustrating an operation for requesting relay function activation to the node included in the potential RS list in the BS in the multi-hop relay BWA communication system according to the present invention.

Referring to FIG. 5, the BS determines to activate the relay function for an RS-capable node now not serving as an RS in order to increase system capacity or expand its service area in step 511. The BS selects a node from the potential RS list in step 513 and sends a Relay Station De/Activate Response (RS_DEACT-RSP) message with an RS activation request code set therein to the node in step 515.

The RS_DEACT-RSP message has the following configuration.

TABLE 1

| | Size | |
|---|---|---|
| Syntax | (bits) | Notes |
| RS_DEACT-RSP message { | | |
| Management Message | 8 | Not defined |
| Type=TBD | | |
| CID | 16 | Target node's basic CID |
| Action code | 2 | 00: request to activate target |
| | | node's relay function |
| | | 01: request to deactivate target |
| | | node's relay function |
| | | 10: reject target node's |
| | | deactivation request |
| | | 11: confirm target node's |
| | | deactivation request |
| | | (notes: if action code is set to |
| | | 01 or 11, the target node shall |
| | | deactivate its relay function.) |
| Reserved | 5 | Shall be set to zero |
| } | | |

Referring to Table 1, the RS_DEACT-RSP message includes a Management Message Type indicating the message type of the transmitted message, a Connection Identifier (CID) indicating the CID of the node to receive the RS_DEACT-RSP message, and an Action code indicating the purpose of sending the RS_DEACT-RSP message. While the CID is described as a basic CID, it is a mere example. It is obvious that any ID identifying the node such as the Medium Access Control (MAC) address of the node can substitute for the basic CID. The BS requests the node to activate the relay function by setting the Action code to 00 and requests the node to deactivate the relay function by setting the Action code to 01. If the Action code is set to 10, this implies that the BS rejects a relay function deactivation request from the node. If the Action code is set to 11, this implies that the BS confirms the relay function deactivation request from the node. When receiving an RS-DEACT-RSP message with the Action code set to 01 or 11, the node has to deactivate its relay function.

In step 517, the BS receives a Relay Station De/Activate Request (RS_DEACT-REQ) message in response to the RS_DEACT-RSP message from the node.

The RS_DEACT-REQ message is configured as follows.

TABLE 2

| | Size | |
|---|---|---|
| Syntax | (bits) | Notes |
| RS_DEACT-REQ message | | |
| { | | |
| Management Message | 8 | Not defined |
| Type=TBD | | |
| CID | 16 | Node's basic CID |
| Action code | 2 | 00: request to deactivate its relay |
| | | function |
| | | 01: confirm to deactivate its relay |
| | | function |
| | | 10: confirm to activate its relay |
| | | function |
| | | 11: reject to activate its relay |
| | | function |
| Reserved | 5 | Shall be set to zero |
| } | | |

Referring to Table 2, the RS_DEACT-REQ message includes a Management Message Type indicating the message type of the transmitted message, a CID indicating the CID of the node that sends the RS_DEACT-REQ message, and an Action code indicating the purpose of sending the RS_DEACT-REQ message. While the CID is described as a basic CID, it is a mere example. It is obvious that any ID identifying the node such as the MAC address of the node can substitute for the basic CID. The node requests the BS to deactivate the relay function by setting the Action code to 00 and confirms a relay function deactivation request from the BS by setting the Action code to 01. If the Action code is set to 10, this implies that the node approves/confirms a relay function activation request from the BS. If the Action code is set to 11, this implies that the node rejects the relay function activation request from the BS.

In step 519, the BS determines from the RS_DEACT-REQ message whether the node has confirmed the BS's relay function activation request. If the node has confirmed, i.e. the Action code is 10 in the RS_DEACT-REQ message, the BS adds the node to the RS list and deletes the node from the potential RS list in step 521. In contrast, if the node has rejected, i.e. the Action code is 11 in the RS_DEACT-REQ message, the BS keeps the node in the potential RS list in step 523.

FIG. 6 is a flowchart illustrating an operation of the node when it receives the relay function activation request from the BS in the multi-hop relay BWA communication system according to the present invention.

Referring to FIG. 6, a node listed in the potential RS list performs a communication procedure as a normal node without functioning as an RS in step 611. Upon receipt of an RS_DEACT-RSP message requesting relay function activation, i.e. an RS_DEACT-RSP message having Action code set to 00 in step 613, the node determines whether to confirm the relay function activation request from the BS in step 615. The determination is made based on requirements for the relay function, such as battery power, reception power, and security-associated considerations.

When determining to confirm the relay function activation request, the node replies with an RS_DEACT-REQ message including Action code set to 10 in step 617 and performs a communication procedure as an RS in step 619.

When determining to reject the relay function activation request, the node replies to the BS with an RS_DEACT-REQ message including Action code set to 11 in step 621 and continues to operate as a normal node in step 623.

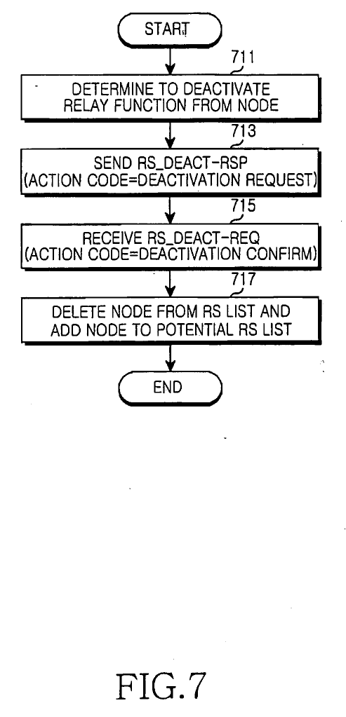

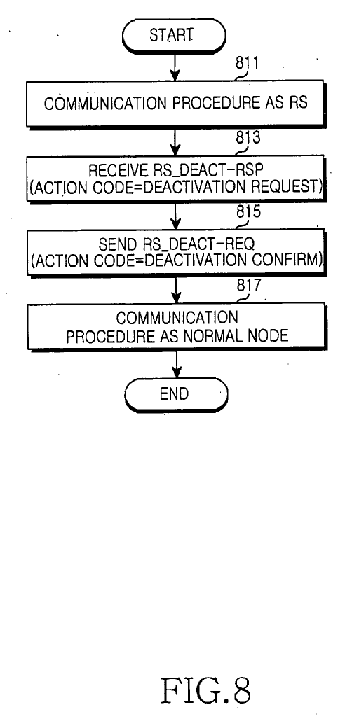

Now an operation between the BS and the node in the case where the BS requests the node to deactivate its ongoing relay function will be described with reference to FIGS. 7 and 8.

FIG. 7 is a flowchart illustrating an operation for requesting relay function deactivation to the node in the BS in the multi-hop relay BWA communication system according to the present invention.

Referring to FIG. 7, the BS determines to deactivate the relay function from a node now serving as an RS in order to optimize system performance in step 711. The BS sends an RS_DEACT-RSP message requesting relay function deactivation, i.e. an RS_DEACT-RSP message with Action code set to 01 to the node in step 713.

In step 715, the BS receives an RS_DEACT-REQ message with Action code set to 01, i.e. confirmation of relay function deactivation from the node. The BS then deletes the node from the RS list, adding the node to the potential list in step 717 and ends the process.

FIG. 8 is a flowchart illustrating an operation of the node when it receives the relay function deactivation request from the BS in the multi-hop relay BWA communication system according to the present invention.

Referring to FIG. 8, a node listed in the RS list performs a communication procedure as an RS in step 811. Upon receipt of an RS_DEACT-RSP message requesting relay function deactivation, i.e. an RS_DEACT-RSP message having Action code set to 01 in step 813, the node replies with an RS_DEACT-REQ message including Action code set to 01, i.e. confirmation of relay function deactivation in step 815 and performs a communication procedure as a normal node in step 817. The node then ends the process.

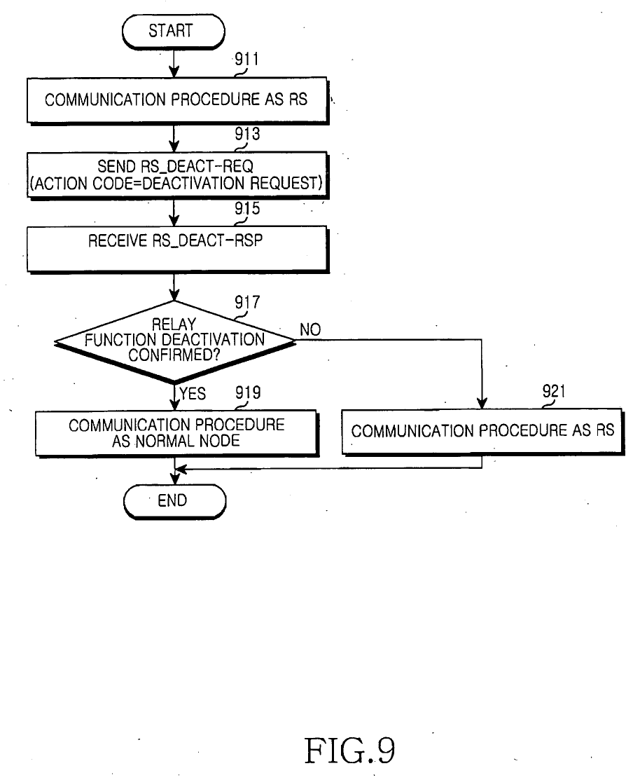

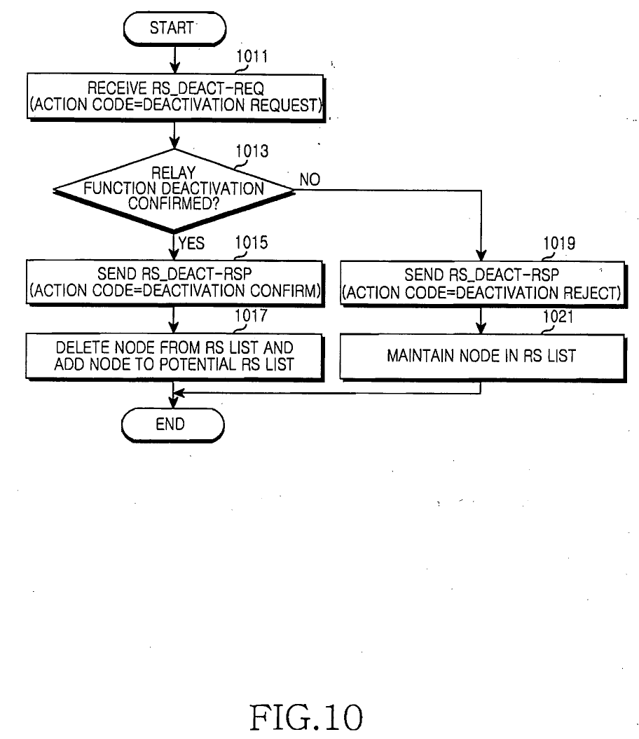

With reference to FIGS. 9 and 10, an operation between the node and the BS in the case where the node requests relay function deactivation to the BS will be described below.

FIG. 9 is a flowchart illustrating an operation for requesting relay function deactivation to the BS in the node serving as an RS in the multi-hop relay BWA communication system according to the present invention.

Referring to FIG. 9, the node performs a communication procedure as an RS in step 911. When it determines to deactivate the relay function, the node sends an RS_DEACT-REQ message requesting relay function deactivation, i.e. an RS_DEACT-REQ message with Action code set to 00 to the BS in step 913.

In step 915, the node receives an RS_DEACT-RSP message from the BS and checks the value of Action code set in the message. If the BS confirms the relay function deactivation request, i.e. the RS_DEACT-RSP message includes Action code to 11, in step 917, the node performs a communication procedure as a normal node in step 919. On the other hand, if the BS rejects the relay function deactivation request, i.e. the RS_DEACT-RSP message includes Action code to 10, the node continues the communication procedure as the RS in step 921.

FIG. 10 is a flowchart illustrating an operation of the BS, when it receives the relay function deactivation request from the node in the multi-hop relay BWA communication system according to the present invention.

Referring to FIG. 10, upon receipt of an RS_DEACT-REQ message requesting relay function deactivation, i.e. an RS_DEACT-REQ message with Action code set to 00 from the node in step 1011, the BS determines whether to confirm the relay function deactivation request in step 1013. The determination may be made for the purpose of increasing system capacity or expanding the coverage area of the BS.

If it determines to confirm the relay function deactivation request, the BS sends an RS_DEACT-RSP message with Action code set to 11 to the node in step 1015 and deletes the node from the RS list, adding the node to the potential RS list in step 1017. If it determines to reject the relay function deactivation request, the BS sends an RS_DEACT-RSP message with Action code set to 10 to the node in step 1019 and keeps the node in the RS list in step 1021.

In the case where the relay function is deactivated from the node acting as an RS as described above with reference to FIGS. 7 to 10, the BS or the node requests a lower-layer node communicating with the BS through relaying of the node to perform a handover to the BS or another RS so as to ensure communication continuity for the lower-layer node. The handover is beyond the scope of the present invention and thus will not be described in detail herein.

Meanwhile, if the BS communicates with the node not directly but via an upper-layer RS, the RS_DEACT-RSP message and the RS_DEACT-REQ message are exchanged between them via the upper-layer RS.

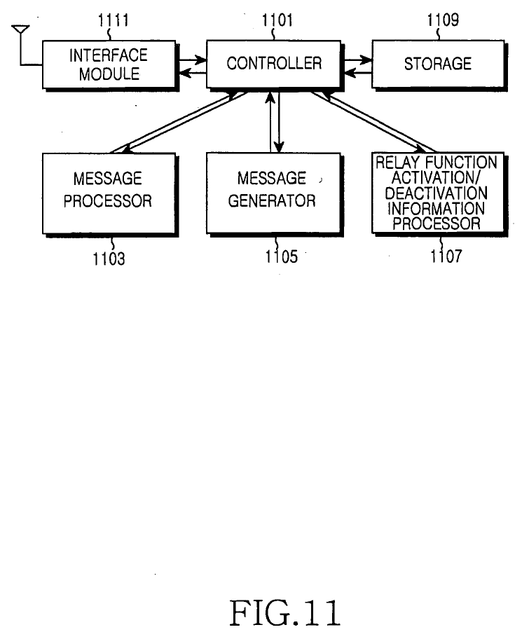

FIG. 11 is a block diagram of the node or the BS according to the present invention.

Since the node and the BS have identical interface modules (communication modules), they have the same configuration. Thus, their operations will be described mainly in relation to processing control messages, taking into consideration a single device.

Referring to FIG. 11, in the node, a controller 1101 provides overall control to the node. For example, the controller 1101 processes and controls voice communication and data communication. In addition to the typical functionalities, the controller 1101 performs an operation associated with relay function activation/deactivation information according to the present invention. The controller 1101 provides a control message received from the BS directly or via an RS to a message processor 1103, and provides a message to be sent to the BS directly or via the RS, received from a message generator 1105 to an interface module 1111.

The message processor 1103 disassembles the control message received from the BS directly or via the RS and notifies the controller 1101 of the disassembly result. According to the present invention, upon receipt of an RS_DEACT-RSP message illustrated in Table 1, the message processor 1103 extracts control information from the message and provides the control information to the controller 1101. The controller 1101 then controls a relay function activation/deactivation information processor 1107 in accordance with the control information.

The message generator 1105 generates a message to be transmitted to the BS directly or via the RS under the control of the controller 1101 and provides the message to the interface module 1111 through the controller 1101. The message can be an RS_DEACT-REQ message illustrated in Table 2.

The relay function activation/deactivation information processor 1107 provides information required for performing a communication procedure with the BS in correspondence with relay function activation/deactivation parameters to the controller 1101.

A storage 1109 stores programs for controlling the overall operations of the node and temporary data generated during execution of the programs. That is, the storage 1109 can store data and control information that the node will send to the BS directly or via the RS.

The interface module 1111 is used to communicate with the BS directly or via the RS, including a Radio Frequency (RF) processor and a baseband processor. The RF processor downconverts a signal received through an antenna to a baseband signal and provides the baseband signal to the baseband processor. For transmission, the RF processor upconverts a baseband signal received from the baseband processor to an RF signal and sends the RF signal in the air through the antenna. If a BWA scheme is used, the baseband processor Fast Fourier Transform (FFT)-processes the signal received from the RF processor, channel-decodes the FFT signal, and provides the resulting original information data to the controller 1101. For transmission, the baseband processor channel-encodes and Inverse Fast Fourier Transform (IFFT)-processes data received from the controller 1101 and provides the IFFT signal to the RF processor.

With reference to FIG. 11, the structure of the BS will be described.

Referring to FIG. 11, in the BS, the controller 1101 provides overall control to the BS. For example, the controller 1101 processes and controls voice communication and data communication. In addition to the typical functionalities, the controller 1101 performs an operation associated with processing relay function activation/deactivation information according to the present invention. The controller 1101 provides a control message received from the node directly or via the RS as received from the message generator 1105 to the interface module 1111.

The message processor 1103 disassembles the control message received from the node directly or via the RS and notifies the controller 1101 of the disassembly result. According to the present invention, upon receipt of an RS_DEACT-REQ message illustrated in Table 2 from the node, the message processor 1103 extracts control information from the message and provides the control information to the controller 1101. The controller 1101 then operates in accordance with the control information.

The message generator 1105 generates a message to be sent to the node directly or via the RS under the control of the controller 1101 and provides the message to the controller 1101. For example, the message can be an RS_DEACT-RSP message illustrated in Table 1. The generated message is provided to the interface module 1111 through the controller 1101.

The relay function activation/deactivation information processor 1107 manages nodes that acquire relay function activation/deactivation information under the control of the controller 1101. Also, the relay function activation/deactivation information processor 1107 recognizes a node managed by the BS, for which the relay function will be activated, and a node from which the relay function will be deactivated. It also performs an operation for recognizing the need for relay function activation/deactivation.

The storage 1109 stores programs for controlling the overall operations of the BS and temporary data generated during execution of the programs. That is, the storage 1109 can store data and control information that the BS will send to the node directly or via the RS.

The interface module 1111 is used to communicate with the node directly or via the RS, including the RF processor and the baseband processor. The RF processor downconverts a signal received through an antenna to a baseband signal and provides the baseband signal to the baseband processor. For transmission, the RF processor upconverts a baseband signal received from the baseband processor to an RF signal and sends the RF signal in the air through the antenna. If a BWA scheme is used, the baseband processor FFT-processes the signal received from the RF processor, channel-decodes the FFT signal, and provides the resulting original information data to the controller 1101. For transmission, the baseband processor channel-encodes and IFFT-processes data received from the controller 1101 and provides the IFFT signal to the RF processor.

In the above-described configurations of the node and the BS, the controller 1101 controls the message processor 1103, the message generator 1105, and the relay function activation/deactivation information processor 1107. In other words, the controller 1101 can perform the functions of the message processor 1103, the message generator 1105, and the relay function activation/deactivation information processor 1107. While the message processor 1103, the message generator 1105, and the relay function activation/deactivation information processor 1107 are shown separately in FIG. 11 for illustrative purposes, all or part of their functions may be incorporated into the controller 1101 in real implementation.

In accordance with the present invention as described above, a relay function is activated or deactivated for an RS-capable node that can establish a multi-hop relay path during an initial connection procedure with a BS or during communications with the BS in an OFDM/OFDMA BWA communication system. Therefore, system capacity is increased and the coverage area of the BS is expanded. As a consequence, system efficiency is increased.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method of negotiating a Relay Station (RS) capability in a Base Station (BS) in a wireless access communication system, comprising the steps of:
receiving a message including RS capability information from a node which has initially been connected;
determining whether to activate a relay function for the node according to the RS capability information;
sending to the node a message indicating whether the relay function will be activated for the node.

2. The method of claim 1, further comprising:
setting the node as an RS and adding the node to an RS list, if the message sent to the node indicates that the relay function will be activated for the node; and
setting the node as a potential RS and adding the node to a potential RS list, if the message sent to the node indicates that the relay function will not be activated for the node.

3. The method of claim 1, wherein the RS capability information indicates whether the node supports at least one of the relay function, a fixed RS capability, a nomadic RS capability, a mobile RS capability, an infrastructure RS capability, and a client RS capability.

4. The method of claim 1, wherein the determination step comprises determining whether to activate the relay function for the node for at least one of the purposes of expanding the coverage area of the BS and increasing system capacity.

5. The method of claim 2, wherein the potential RS list includes information about RS-capable nodes for which relay function activation was not confirmed during an initial connection procedure but for which the relay function may be activated during communications.

6. A method of negotiating relay function activation in a Base Station (BS) in a wireless access communication system, comprising the steps of:
determining whether to activate a relay function for a Relay Station (RS)-capable node, selecting a node from a potential RS list when determining that the relay function needs to be activated for the RS-capable node, and sending a relay function activation request message to the selected node; and
receiving from the node a relay function activation response message indicating whether the relay function activation request is confirmed or rejected.

7. The method of claim 6, further comprising:
deleting the node from the potential RS list and adding the node to an RS list, if the relay function activation response message indicates that the relay function activation request is confirmed; and
maintaining the node in the potential RS list, if the relay function activation response message indicates that the relay function activation request is rejected.

8. The method of claim 6, wherein the determination step comprises determining whether the relay function needs to be activated for the RS-capable node for at least one of the purposes of expanding the coverage area of the BS and increasing system capacity.

9. The method of claim 6, wherein the relay function activation request message or the relay function activation response message includes at least one of a management message type indicating the message, the Connection Identifier (CID) of the node, and an action code indicating the purpose of sending the message.

10. A method of negotiating relay function activation in a node in a wireless access communication system, comprising the steps of:
receiving a relay function activation request message from a Base Station (BS) during a communication procedure as a normal node;
determining whether to confirm or reject the relay function activation request; and
sending to the BS a relay function activation response message indicating whether the relay function activation request is confirmed or rejected.

11. The method of claim 10, further comprising:
performing a communication procedure as a Relay Station (RS), if the relay function activation response message indicates that the relay function activation request is confirmed; and
continuing the communication procedure as the normal node, if the relay function activation response message indicates that the relay function activation request is rejected.

12. The method of claim 10, wherein the determination step comprises determining whether to confirm or reject the relay function activation request for at least one of battery power, reception power, and security.

13. The method of claim 10, wherein the relay function activation request message or the relay function activation response message includes at least one of a management message type indicating the message, the Connection Identifier (CID) of the node, and an action code indicating the purpose of sending the message.

14. A method of negotiating relay function deactivation in a Base Station (BS) in a wireless access communication system, comprising the steps of:
determining whether to deactivate a relay function from a node functioning as a Relay Station (RS) and sending a relay function deactivation notification message to the node, when determining to deactivate the relay function from the node; and
receiving from the node a relay function deactivation response message confirming the relay function deactivation notification.

15. The method of claim 14, further comprising, upon receipt of the relay function deactivation response message, deleting the node from an RS list and adding the node to a potential RS list.

16. The method of claim 14, wherein the determination step comprises determining whether to deactivate the relay function from the node for at least one of the purposes of expanding the coverage area of the BS and increasing system capacity.

17. The method of claim 14, wherein the relay function deactivation notification message or the relay function deactivation response message includes at least one of a management message type indicating the message, the Connection Identifier (CID) of the node, and an action code indicating the purpose of sending the message.

18. A method of negotiating relay function deactivation in a node in a wireless access communication system, comprising the steps of:
receiving a relay function deactivation notification message from a Base Station (BS) during a communication procedure as a Relay Station (RS); and
sending to the BS a relay function deactivation response message confirming the relay function deactivation notification.

19. The method of claim 18, further comprising performing a communication procedure as a normal node, after sending the relay function deactivation response message.

20. The method of claim 18, wherein the relay function deactivation notification message or the relay function deactivation response message includes at least one of a management message type indicating the message, the Connection Identifier (CID) of the node, and an action code indicating the purpose of sending the message.

21. A method of negotiating relay function deactivation in a node in a wireless access communication system, comprising the steps of:
determining whether to deactivate a relay function during a communication procedure as a Relay Station (RS), and sending a relay function deactivation request message to a Base Station (BS), if determining to deactivate the relay function; and
receiving from the BS a relay function deactivation response message indicating whether the relay function deactivation request is confirmed or rejected.

22. The method of claim 21, further comprising:
performing a communication procedure as a normal node, if the relay function deactivation response message indicates that the relay function deactivation request is confirmed; and
continuing the communication procedure as the RS, if the relay function deactivation response message indicates that the relay function deactivation request is rejected.

23. The method of claim 21, wherein the determination step comprises determining whether to deactivate the relay function according to at least one of battery power, reception power, and security.

24. The method of claim 21, wherein the relay function deactivation request message or the relay function deactivation response message includes at least one of a management message type indicating the message, the Connection Identifier (CID) of the node, and an action code indicating the purpose of sending the message.

25. A method of negotiating relay function deactivation in a Base Station (BS) in a wireless access communication system, comprising the steps of:
receiving a relay function deactivation request message from a node;
determining whether to confirm or reject the relay function deactivation request; and
sending to the node a relay function deactivation response message indicating whether the relay function deactivation request is confirmed or rejected.

26. The method of claim 25, further comprising:
deleting the node from an RS list and adding the node to a potential RS list, if the relay function deactivation response message indicates that the relay function deactivation request is confirmed; and
maintaining the node in the RS list, if the relay function deactivation response message indicates that the relay function deactivation request is rejected.

27. The method of claim 25, wherein the determination step comprises determining whether to confirm or reject the relay function deactivation request for at least one of the purposes of expanding the coverage area of the BS and increasing system capacity.

28. The method of claim 25, wherein the relay function deactivation request message or the relay function deactivation response message includes at least one of a management message type indicating the message, the Connection Identifier (CID) of the node, and an action code indicating the purpose of sending the message.

29. A method of negotiating relay function activation in a wireless access communication system, comprising the steps of:
determining whether to activate a relay function for a Relay Station (RS)-capable node, selecting a node from a potential RS list when determining to activate the relay function for the RS-capable node, and sending a relay function activation request message to the selected node by a Base Station (BS); and
determining whether to confirm or reject the relay function activation request and sending to the BS a relay function activation response message indicating whether the relay function activation request is confirmed or rejected.

30. The method of claim 29, further comprising:
deleting the node from the potential RS list and adding the node to an RS list by the BS, if the relay function activation response message indicates that the relay function activation request is confirmed; and
maintaining the node in the potential RS list by the BS, if the relay function activation response message indicates that the relay function activation request is rejected.

31. The method of claim 29, wherein the step of determining whether to activate a relay function for an RS-capable node comprises determining whether to activate the relay function for the RS-capable node for at least one of the purposes of expanding the coverage area of the BS and increasing system capacity.

32. The method of claim 29, further comprising:
performing a communication procedure as an RS, if the relay function activation response message indicates that the relay function activation request is confirmed; and
continuing the communication procedure as a normal node, if the relay function activation response message indicates that the relay function activation request is rejected.

33. The method of claim 29, wherein the step of determining whether to confirm or reject the relay function activation request comprises determining whether to confirm or reject the relay function activation request according to at least one of battery power, reception power, and security.

34. The method of claim 29, wherein the relay function activation request message or the relay function activation response message includes at least one of a management message type indicating the message, the Connection Identifier (CID) of the node, and an action code indicating the purpose of sending the message.

35. A method of negotiating relay function deactivation in a wireless access communication system, comprising the steps of:
determining whether to deactivate a relay function from a node functioning as a Relay Station (RS) and sending a relay function deactivation notification message to the node by a Base Station (BS), when determining to deactivate the relay function from the node; and
sending to the BS a relay function deactivation response message confirming the relay function deactivation notification by the node.

36. The method of claim 35, further comprising, upon receipt of the relay function deactivation response message from the node, deleting the node from an RS list and adding the node to a potential RS list by the BS.

37. The method of claim 35, further comprising performing a communication procedure as a normal node by the node, after sending the relay function deactivation response message.

38. The method of claim 35, wherein the determination step comprises determining whether to deactivate the relay function from the node for at least one of the purposes of expanding the coverage area of the BS and increasing system capacity.

39. The method of claim 35, wherein the relay function deactivation notification message or the relay function deactivation response message includes at least one of a management message type indicating the message, the Connection Identifier (CID) of the node, and an action code indicating the purpose of sending the message.

40. A method of negotiating relay function deactivation in wireless access communication system, comprising the steps of:
determining whether to deactivate a relay function during a communication procedure as a Relay Station (RS), and sending a relay function deactivation request message to a Base Station (BS) by a node, if determining to deactivate the relay function; and
determining whether to confirm or reject the relay function deactivation request and sending to the node a relay function deactivation response message indicating whether the relay function deactivation request is confirmed or rejected by the BS.

41. The method of claim 40, further comprising:
deleting the node from a RS list and adding the node to a potential RS list by the BS, if the relay function deactivation response message indicates that the relay function deactivation request is confirmed; and
maintaining the node in the RS list by the BS, if the relay function deactivation response message indicates that the relay function deactivation request is rejected.

42. The method of claim 40, further comprising:
performing a communication procedure as a normal node by the node, if the relay function deactivation response message indicates that the relay function deactivation request is confirmed; and
continuing the communication procedure as the RS by the node, if the relay function deactivation response message indicates that the relay function deactivation request is rejected.

43. The method of claim 40, wherein the step of determining whether to confirm or reject the relay function deactivation request comprises determining whether to confirm or reject the relay function deactivation request for at least one of the purposes of expanding the coverage area of the BS and increasing system capacity.

44. The method of claim 40, wherein the step of determining whether to deactivate the relay function comprises determining whether to deactivate the relay function according to at least one of battery power, reception power, and security.

45. The method of claim 40, wherein the relay function deactivation request message or the relay function deactivation response message includes at least one of a management message type indicating the message, the Connection Identifier (CID) of the node, and an action code indicating the purpose of sending the message.

46. An apparatus for negotiating a Relay Station (RS) capability in a wireless access communication system, comprising:
a Base Station (BS) for determining whether to activate or deactivate a relay function for a node, sending a first relay function activation or deactivation request message to the node, receiving from the node a first relay function activation or deactivation response message indicating whether the relay function activation or deactivation request is confirmed or rejected, determining whether to confirm or reject a relay function deactivation request upon receipt of a second relay function deactivation request message from the node, and sending to the node a second relay function deactivation response message indicating whether the relay function deactivation request is confirmed or rejected; and
the node for, upon receipt of the first relay function activation or deactivation request message from the BS, determining whether to confirm or reject the relay function activation or deactivation request, sending the first relay function activation or deactivation response message indicating whether the relay function activation or deactivation request is confirmed or rejected, determining whether to deactivate the relay function, and sending the second relay function deactivation request message to the BS when determining to deactivate the relay function.

47. The apparatus of claim 46, wherein the step of determining whether to activate or deactivate a relay function for a node comprises determining whether to activate or deactivate the relay function for the node according to at least one of the purposes of expanding the coverage area of the BS and increasing system capacity.

48. The apparatus of claim 46, wherein the step of determining whether to confirm or reject the relay function activation or deactivation request comprises determining whether to confirm or reject the relay function activation or deactivation request according to at least one of battery power, reception power, and security.

49. The apparatus of claim 46, wherein the first relay function activation or deactivation request message, the first relay function activation or deactivation response message, the second relay function deactivation request message, or the second relay function deactivation response message includes at least one of a management message type indicating the message, the Connection Identifier (CID) of the node, and an action code indicating the purpose of sending the message.
